(19) United States
(12) Patent Application Publication
(10) Pub. No.: US 2017/0095886 A1
(43) Pub. Date: Apr. 6, 2017

(54) Process and System for Laser Welding Pre-Coated Sheet Metal Workpieces

(71) Applicant: Magna International Inc., Aurora (CA)

(72) Inventors: Hongping Gu, Newmarket (CA); Boris Shulkin, West Bloomfield, MI (US); Robert Mueller, Milton (CA); Jeremiah John Brady, Knoxville, TN (US)

(21) Appl. No.: 15/311,832

(22) PCT Filed: Jun. 19, 2015
(86) PCT No.: PCT/CA2015/000403

§ 371 Date: Nov. 16, 2016

Related U.S. Application Data
(60) Provisional application No. 62/014,299, filed on Jun. 19, 2014.

(51) Int. Cl. B23K 26/06; B23K 26/322

(52) U.S. Cl. CPC B23K 26/0608; B23K 26/322; B23K 2203/04

(57) ABSTRACT

A process for laser-welding pre-coated sheet metal plates comprises loading two pre-coated sheet metal plates at a workstation, such that edges of the plates that are to be welded together are butted against one another. Each plate has a steel substrate and a pre-coat layer, the pre-coat layer including an intermetallic alloy layer and a metallic alloy layer. In a single pass, an area of each plate adjacent to the edges that are butted against one another is irradiated with a defocussed laser beam, thereby melting material of the pre-coat layer within said area of each plate. During the single pass, a stream of a gas is used to blow the melted pre-coat material out of the irradiated areas of the two plates. Absent removing the two plates from the workstation, laser-welding the plates together is performed using a focused laser beam.

### CROSS REFERENCE TO RELATED APPLICATIONS

This document is a National Stage Application submitted under 35 U.S.C. 371 of PCT application PCT/CA2015/000403, having an international filing date of Jun. 19, 2015, listing as first inventor Hongping Gu, titled “Process and System for Laser Welding Pre-Coated Sheet Metal Workpieces,” which in turn claims the benefit of the filing date of U.S. Provisional Pat. App. No. 62/014,299, filed Jun. 19, 2014, listing as first inventor Hongping Gu, titled “Process and System for Forming Butt-Welded Blanks,” the disclosures of each of which are hereby incorporated entirely herein by reference.

### FIELD OF THE INVENTION

The present invention relates generally to a process and system for fabricating sheet metal components, such as for instance components for use in automobiles and other assemblies. More particularly, the present invention relates to a process and system for laser welding pre-coated sheet metal plates to form butt-welded blanks, or for joining together sheet-formed components and the like.

### BACKGROUND OF THE INVENTION

The automotive industry faces an ongoing challenge of improving safety and crash-survivability of the automobiles it produces, while at the same time improving fuel efficiency to meet or exceed legislated minimum standards. One way of achieving both goals relies on the use of lighter weight materials that possess excellent mechanical strength, high impact resistance, etc. In this way the overall weight of the vehicle can be reduced, so as to achieve improved fuel efficiency, without sacrificing the capacity to absorb impact energy in the event of a collision. This strategy is widely employed to produce anti-intrusion, structural or safety components of automotive vehicles, such as for instance bumpers, door reinforcements, B-pillar reinforcements and roof reinforcements.

For instance, “butt-welded blanks” are formed by joining together, preferably by laser welding, two or more steel blanks of different compositions and/or different thicknesses. After the welded-blanks have been cold-pressed, parts are obtained having properties of mechanical strength, pressability and impact absorption that vary within the parts themselves. It is therefore possible to provide different mechanical properties at different locations within a part, without imposing an unnecessary or costly penalty on the entire part. For instance a B-pillar may be obtained by joining together a first steel blank having a high mechanical strength and a second steel blank having a relatively lower mechanical strength. During an impact, deformation is concentrated within the portion of the B-pillar that is formed from the second steel blank, such that the energy of the impact is safely absorbed in a desired fashion.

In order to avoid the need to provide a controlled furnace atmosphere during hot forming of the welded blanks, and to provide corrosion resistance, it is common to fabricate such blanks using coated sheet metal materials, such as for instance boron steels with an aluminum-silicon pre-coating. Unfortunately, the process of laser welding such pre-coated sheet metal materials results in some of the pre-coat material being transferred into the molten area that is created during the welding operation. Subsequent austenizing and quenching of the welded blank results in the metal elements from the pre-coat material becoming alloyed with the iron or other elements of the steel sheet, thereby forming brittle, intermetallic compounds in the welded joint. On subsequent mechanical loading, these intermetallic compounds tend to be the site of onset of rupture under static or dynamic conditions. As such, the overall deformability of the welded joints after heat treatment is significantly reduced by the presence of these intermetallic compounds resulting from welding and subsequent alloying and austenizing.

In U.S. Pat. No. 8,614,008, Canourgues et al. note that it is desirable to eliminate the source of the above-mentioned intermetallic compounds, namely the initial surface metal coating that is likely to be melted during laser welding. However, simply eliminating the pre-coated area on either side of the future weld joint results, after the welding operation, in areas on either side of the welded joint that no longer have any surface metal pre-coating. This occurs because the width of the area from which the pre-coating is removed must be at least equal to the width of the area that is melted during welding, so as not to encourage subsequent formation of intermetallic areas. Canourgues et al. note that in practice the width of pre-coat that is removed must be much more than this minimum amount to allow for fluctuations in the width of the molten area during the assembly operation. Unfortunately, during further alloying and austenizing heat treatment, scale formation and decarburizing occurs within the uncoated areas that are located next to the weld. Further, it is these uncoated and therefore unprotected areas that tend to corrode when the parts go into service.

Canourgues et al. go on to disclose their surprising discovery that eliminating only a portion of the pre-coat is still effective to solve the above-noted corrosion problem. In particular, their solution involves removing the entire thickness of the metal alloy layer while leaving in place the underlying intermetallic alloy layer that is in contact with the steel substrate. Canourgues et al. stress the precise removal of the metal alloy layer, including measuring the emissivity or reflectivity of the surface that is exposed during the removal process, and stopping the removal when a difference between the measured value and a reference value exceeds a critical threshold. Since the intermetallic alloy layer remains undisturbed during the removal of the metal alloy layer, the width of the area from which the metal alloy layer is removed may be 20-40% larger than the half width of the weld. During the welding process the metal alloy layer cannot melt into the weld pool, and as such the intermetallic areas do not form along the welded joint. The undisturbed intermetallic alloy layer on either side of the welded joint provides protection against corrosion when the part goes into service, but does not contribute significantly to the formation of intermetallic compounds in the welded joint.

The solution that is disclosed by Canourgues et al. is elegant and results in a strong weld joint that is protected against corrosion, but it is also very difficult to implement in practice. In particular, it is very difficult to achieve precise removal of the metal alloy layer by mechanical brushing or laser ablation while leaving the underlying intermetallic alloy undisturbed. Further, the process is time consuming and labor intensive, since each part of a welded blank must be handled separately, placed in a first work station to undergo removal of the metal alloy layer, moved to a second work station and positioned relative to another part of the welded blank, and then finally the separate parts are welded together in the second work station. Of course, operating separate work stations for the removal of the metal alloy layer and for the welding process increases floor-space usage requirements, and necessitates the duplication of laser sources and laser optic assemblies, etc. This is necessarily the case because a pulsed-wave laser is used to remove the metal alloy layer and a continuous-wave laser is used to perform laser welding. In particular, Canourgues et al. describe the use of a high energy-density beam, which causes vaporization and expulsion of the surface of the pre-coat.

Of course, the formation of brittle, intermetallic compounds in welded joints is a problem that is also encountered in other applications, such as for instance during the welding of coated, sheet-formed components. In this case, a pre-coated aluminum-silicon steel sheet is hot formed to produce a component having a desired shape. Subsequent welding steps may be performed, such as for instance to join the formed component to a machined part or to join together two edges of the formed component. Unfortunately, the coating material forms undesired intermetallic compounds in the weld joint, which can cause severe cracking and result in the same type of problems that have been described above with reference to butt-welded blanks.

It would be beneficial to overcome at least some of the above-mentioned limitations and disadvantages of the prior art.

### SUMMARY OF THE INVENTION

According to an aspect of at least one embodiment of the instant invention, disclosed is a process for laser-welding, comprising: at a work station, arranging a first workpiece relative to a second workpiece such that the first and second workpieces abut one another along an interface, at least one of the first and second workpieces comprising a steel substrate and a pre-coat layer, the pre-coat layer comprising an intermetallic alloy layer that is in contact with the underlying steel substrate as well as a metallic alloy layer that is in contact with the intermetallic alloy layer; scanning a defocused laser beam along the interface between the first and second workpieces, thereby melting the material of the pre-coat layer within an area that is immediately adjacent to the interface; during scanning of the defocused laser beam and prior to the melted material re-solidifying, directing a stream of a gas toward the melted material, the stream of gas providing sufficient force to blow the melted material off the underlying steel substrate of the at least one of the first and second workpieces; and absent transferring the first and second workpieces from the work station to another work station, scanning a focused laser beam along the interface to form a laser weld joint.

According to an aspect of at least one embodiment of the instant invention, disclosed is a system for laser-welding, comprising: a support for holding a first workpiece in a predetermined orientation relative to a second workpiece, such that the first workpiece abuts the second workpiece along an interface, at least one of the first and second workpieces comprising a steel substrate having a pre-coat layer formed thereon; at least one laser optic assembly in optical communication with a laser source; at least one actuator for relatively moving the at least one laser optic assembly relative to the support; and a conduit in communication with a source of a gas for directing a stream of the gas toward a predetermined point along the interface between the first workpiece and the second workpiece, wherein during use the at least one actuator moves the at least one laser optic assembly relative to the support such that the at least one laser optic assembly scans a defocused laser beam along the interface to melt the material of the pre-coat layer within an area that is immediately adjacent to the interface, and such that the at least one laser optic assembly subsequently scans a focused laser beam along the interface to form a laser weld joint, and wherein the predetermined point along the interface is a point that is behind the defocused laser beam in the scan direction, and the stream of the gas provides sufficient force to blow the melted material of the pre-coat off the underlying steel substrate of the at least one of the first and second workpieces, prior to scanning the focused laser beam to form the laser weld joint.

According to an aspect of at least one embodiment of the instant invention, disclosed is a process for laser-welding pre-coated sheet metal plates to form a butt-welded blank, the process comprising: at a work station, arranging a first pre-coated sheet metal plate relative to a second pre-coated sheet metal plate, such that an edge of the first plate and an edge of the second plate butt against one another and define an interface, each plate comprising a steel substrate and a pre-coat layer, the pre-coat layer comprising an intermetallic alloy layer that is in contact with the steel substrate as well as a metallic alloy layer that is in contact with the intermetallic alloy layer; scanning a defocused laser beam along the interface between the first plate and the second plate, thereby heating contiguous surface regions of the plates that are adjacent to the interface and melting material of the pre-coat layer within each of the contiguous surface regions; during scanning, directing a stream of a gas toward the melted material, the stream of gas providing sufficient force to blow the melted material out of the contiguous surface areas; and absent transferring the first plate and the second plate from the work station to another work station, scanning a focused laser beam along the interface to form a laser weld joint.

According to an aspect of at least one embodiment of the instant invention, disclosed is a system for laser-welding pre-coated sheet metal plates to form a butt-welded blank, the system comprising: a support for holding a first pre-coated sheet metal plate in a predetermined orientation relative to a second pre-coated sheet metal plate, such that an edge of the first plate and an edge of the second plate butt against one another and define an interface; at least one laser optic assembly in optical communication with a laser source; at least one actuator for relatively moving the at least one laser optic assembly relative to the support; and a conduit in communication with a source of a gas for directing a stream of the gas toward a predetermined point along the interface between the first plate and the second plate, wherein during use the at least one actuator moves the at least one laser optic assembly relative to the support such that the at least one laser optic assembly scans a defocused laser beam along the interface to melt at least some material of the pre-coat within contiguous surface areas of the plates adjacent to the interface, and such that the at least one laser optic assembly scans a focused laser beam along the interface to form a laser weld joint, and wherein the predetermined point along the interface is a point that is behind the defocused laser beam in the scan direction, and the stream of the gas provides sufficient force to blow the melted material of the pre-coat out of the contiguous surface areas.

According to an aspect of at least one embodiment of the instant invention, disclosed is a process for laser-welding pre-coated sheet metal plates to form a butt-welded blank, the process comprising: at a work station, loading two pre-coated sheet metal plates such that edges of the plates that are to be welded together are butted against one another, each plate comprising a steel substrate and a pre-coat layer, the pre-coat layer comprising an intermetallic alloy layer that is in contact with the steel substrate as well as a metallic alloy layer that is in contact with the intermetallic alloy layer; in a single pass, irradiating with a defocussed laser beam an area of each plate that is adjacent to the edges that are butted against one another, thereby melting material of the pre-coat layer within said area of each plate; during the single pass, directing a stream of a gas toward the melted material of the pre-coat layer, the stream of the gas providing sufficient force to blow the melted pre-coat material out of the irradiated areas of the two plates; and absent removing the two plates from the work station, laser-welding the plates together using a focused laser beam.

### BRIEF DESCRIPTION OF THE DRAWINGS

The instant invention will now be described by way of example only, and with reference to the attached drawings, wherein similar reference numerals denote similar elements throughout the several views. It should be understood that the drawings are not necessarily to scale. In certain instances, details that are not necessary for an understanding of the disclosure or that render other details difficult to perceive have been omitted.

FIG. 1 is a simplified side view showing two pre-coated sheet metal plates of different thicknesses, prior to being butt-welded together.

FIG. 2 is a simplified side view showing the pre-coated sheet metal plates of FIG. 1 during removal of the pre-coat material, according to an embodiment of the invention.

FIG. 3 is a simplified perspective view showing the pre-coated sheet metal plates of FIG. 1 during removal of the pre-coat material, according to an embodiment of the invention.

FIG. 4 is a simplified side view showing the pre-coated sheet metal plates of FIG. 1 during laser welding, subsequent to removal of the pre-coat material.

FIG. 5 is a simplified perspective view showing the pre-coated sheet metal plates of FIG. 1 during laser welding, subsequent to removal of the pre-coat material.

FIG. 6 is a simplified perspective view showing the use of a beam splitter to effect simultaneous removal of the pre-coat material and laser welding, according to an embodiment of the invention.

FIG. 7 is a simplified perspective view showing the use of separate laser heads to effect simultaneous removal of the pre-coat material and laser welding, according to an embodiment of the invention.

FIG. 8 is a simplified top view showing the use of a dual-beam laser to remove the pre-coat material, according to an embodiment of the invention.

FIG. 9 is a simplified perspective view showing the use of a dual-beam laser to remove the pre-coat material, according to an embodiment of the invention.

FIGS. 10A-D show the various steps in a process for joining a formed component to a machined part, in accordance with an embodiment of the invention.

### DETAILED DESCRIPTION OF THE INVENTION

The following description is presented to enable a person skilled in the art to make and use the invention, and is provided in the context of a particular application and its requirements. In particular, the invention is described in terms of the specific application of forming butt-welded blanks, but it is to be understood that other applications are also envisaged, such as for instance welding coated sheet-formed components. Further, various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

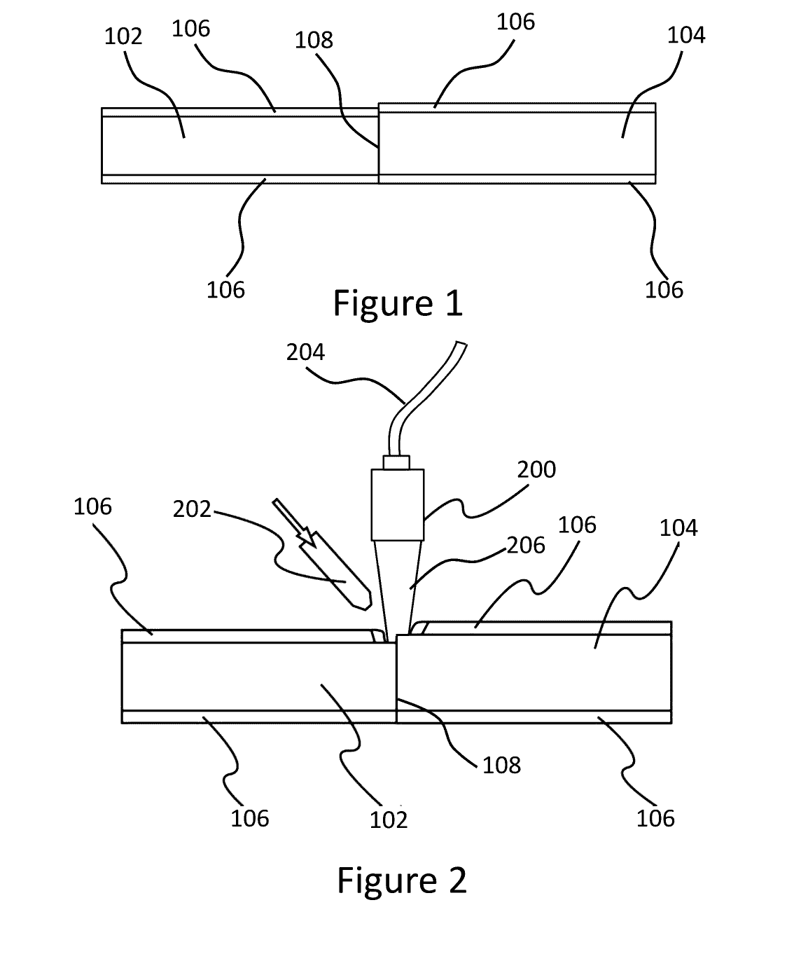

A process and system for laser welding pre-coated workpieces will now be described in the context of a specific example, in which two pre-coated sheet metal plates are butt-welded together to form a butt-welded blank. FIG. 1 is a simplified side view showing two pre-coated sheet metal plates of different thicknesses, prior to being butt-welded together. More particularly, steel substrate 102 is relatively thinner than steel substrate 104. Each substrate 102 and 104 has a pre-coat layer 106 on each side thereof. The pre-coat layer 106 is formed in a known manner, such as for instance by dip-coating the substrates 102 and 104 in a bath of molten aluminum or molten aluminum alloy. Optionally, the pre-coat layer 106 is formed using another suitable material, such as for instance by dip-coating the substrates 102 and 104 in a bath of molten zinc or molten zinc alloy. The plates are arranged such that edges of the plates that are to be welded together are butted against one another and define an interface 108.

For simplicity, the pre-coat layer 106 is depicted in the drawings as a single layer. However, in practice the pre-coat layer 106 comprises an intermetallic alloy layer that is in contact with the steel substrate 102 or 104, and a metallic alloy layer that is in contact with the intermetallic alloy layer. The pre-coat layer 106 typically has a melting temperature that is much lower than the melting temperature of the underlying steel substrate 102 or 104. For instance, an aluminum-silicon alloy coating has a melting temperature lower than 600° C. compared to about 1500° C. for the steel substrate. In the following drawings and in the corresponding text, various processes and a related system are disclosed for forming butt-welded blanks from pre-coated sheet metal plates. The processes take advantage of the above-noted large melting temperature difference. In each of the processes, a continuous-wave laser is used for the localized removal of the pre-coat material within the area that is to be welded, as well as for forming the laser-weld joint. In each case, a high-pressure stream of gas is used to assist in the removal of the pre-coat material, by providing a sufficient force to remove the melted material of the pre-coat layer from within the area that is to be welded.

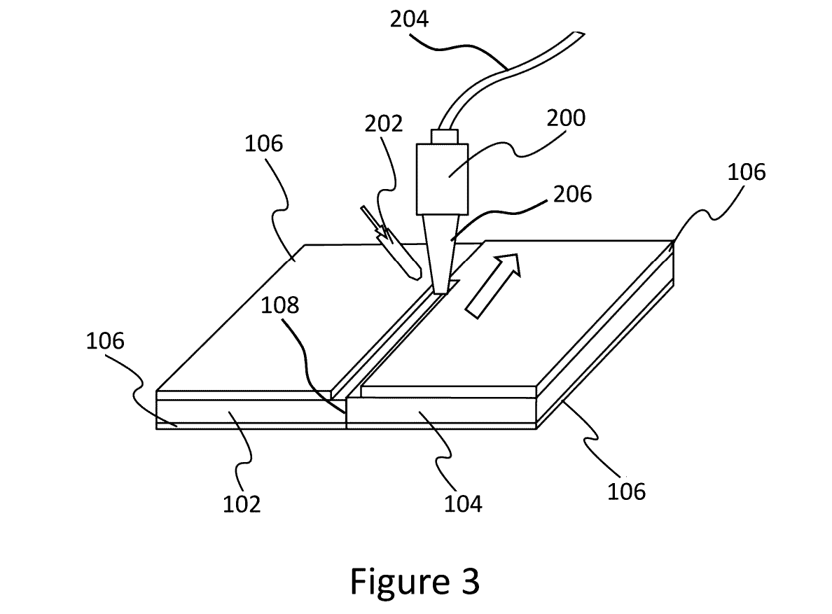

Referring now to FIG. 2, shown is a simplified side view of the pre-coated sheet metal plates of FIG. 1, during localized removal of the pre-coat material 106. Laser optic assembly 200 receives laser light from a continuous-wave laser source via a fiber, referred to collectively as laser source 204, and launches a defocused laser beam 206 toward contiguous surface areas of the plates on either side of the interface 108. By way of an example, the laser optic assembly 200 includes at least a lens, and the fiber of the laser source 204 is either a single core fiber or a multiple core fiber bundle. The defocused laser beam 206 melts material of the pre-coat layer 106 within the contiguous surface areas, but does not vaporize and expel the melted material. Rather, a conduit 202 is used to direct a stream of a gas at the melted material, with sufficient force to blow the melted material out of the contiguous surface areas. The conduit 202 is in fluid communication with a source of high-pressure gas (not shown).

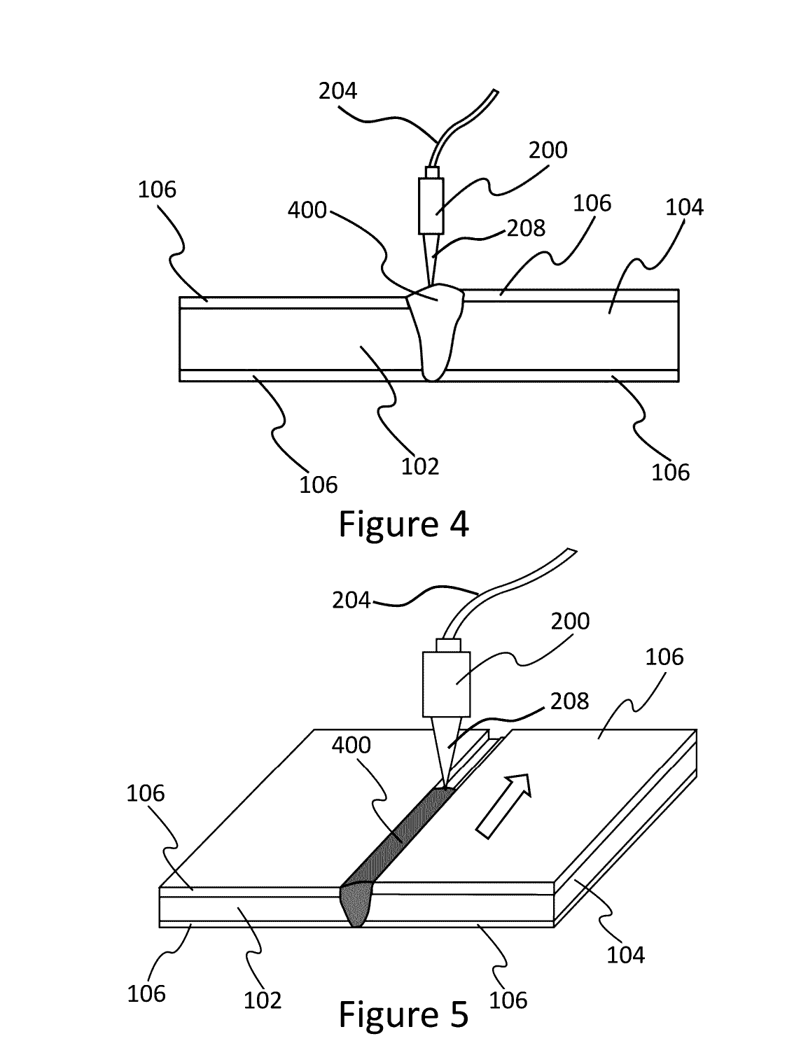

Referring also to FIG. 3, the defocused laser beam 206 is scanned along the interface 108 in a direction that is indicated by the block arrow in the drawing. The conduit 202 follows behind the laser beam 206 in the scan direction, such that the stream of the gas is directed toward melted material that is formed immediately behind the defocused laser beam 206. In this way, the stream of the gas blows the melted material out of the contiguous surface areas before the melted material re-solidifies. Alternatively, the plates are moved in a direction opposite the indicated scan direction, and the laser optic assembly 200 and conduit 202 remain stationary. It is to be understood that as depicted in FIG. 3, the plates are not mechanically joined together but are merely arranged and held in a fixture or another suitable support. More particularly, each plate is positioned and held firmly in place relative to the other plate during removal of the pre-coat layer 106 and during subsequent laser welding.

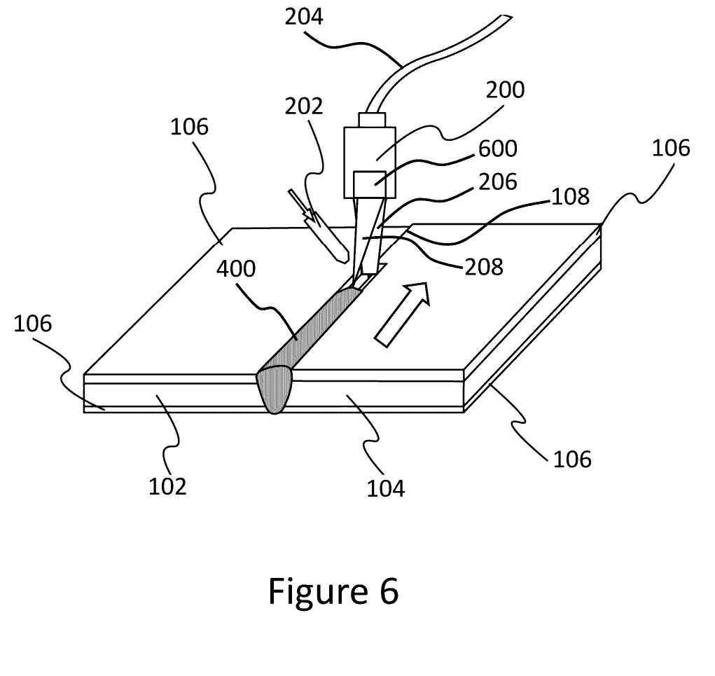

Referring now to FIG. 4, shown is a simplified side view of the pre-coated sheet metal plates of FIG. 1 during laser welding, and subsequent to removal of the pre-coat material within the contiguous surface areas. In FIG. 4, the same laser optic assembly 200 and laser source 204 that were used to remove the pre-coat material are also used to form a laser-weld joint 400 between the substrates 102 and 104. The conduit 202 is not shown in FIG. 4, for improved clarity.

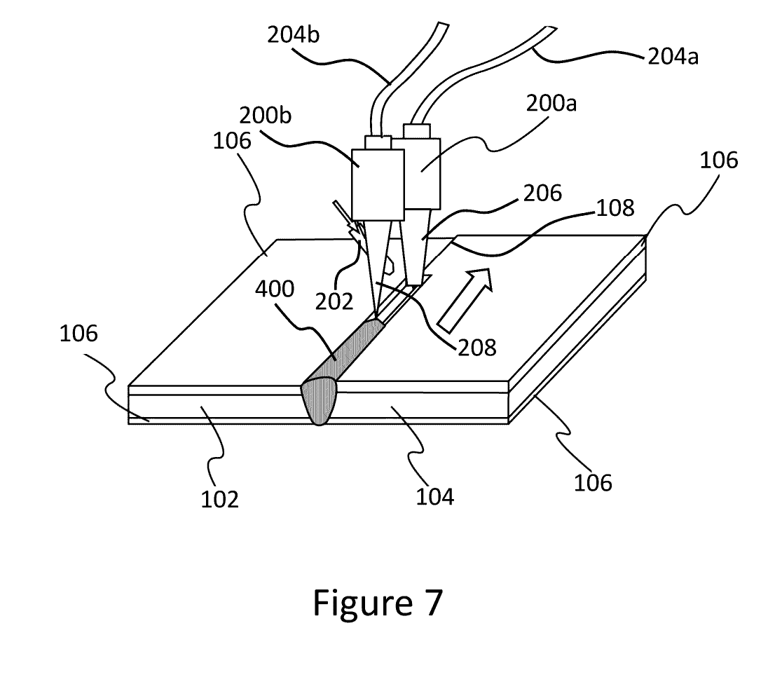

Referring also to FIG. 5, the laser-weld joint 400 is formed during a second pass after the material of the pre-coat layer 106 has been removed from the contiguous surface areas of the plates during a first pass. The laser optic assembly 200 may be scanned in the same direction during the second pass for forming the laser-weld joint 400, and during the first pass for removing the material of the pre-coat layer 106 from the contiguous surface areas of the plates. Optionally, the laser optic is scanned (relative to the plates) in opposite directions for forming the laser-weld joint 400 and for removing the material of the pre-coat layer 106.

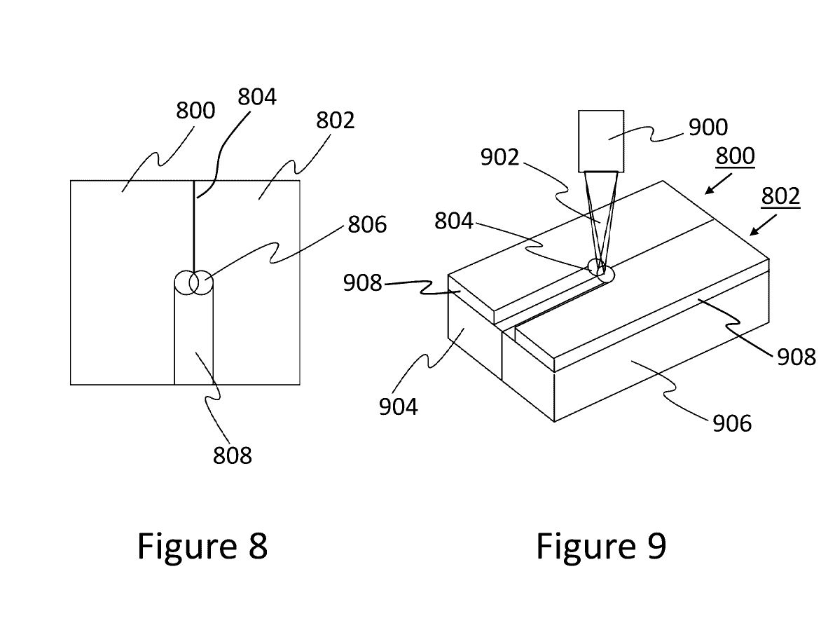

Referring now to FIG. 6, shown is a simplified perspective view illustrating the use of a beam splitter 600 to effect simultaneous removal of the pre-coat material and laser welding, according to an embodiment of the invention. During a single pass, a defocused laser beam 206 and a focused laser beam 208 are scanned along the interface 108 in a scan direction indicated by the block arrow in the figure. Conduit 202 directs a stream of a gas toward material of the pre-coat layer 106 that is melted by the defocussed laser beam 206, and provides sufficient force to blow the melted material out of the contiguous surface areas adjacent to the interface 108. The conduit 202 is in fluid communication with a source of high-pressure gas (not shown). The beam splitter 206 is used to launch the focused laser beam 208 toward the interface 108 to form a laser-weld joint 400 between the substrates 102 and 104. In particular, the focused laser beam is directed toward a region along the interface 108 from which the melted material has been blown out. A single laser source 204 (i.e., continuous-wave laser source and delivery fiber) is used to generate both the focused laser beam 208 and the defocused laser beam 206.

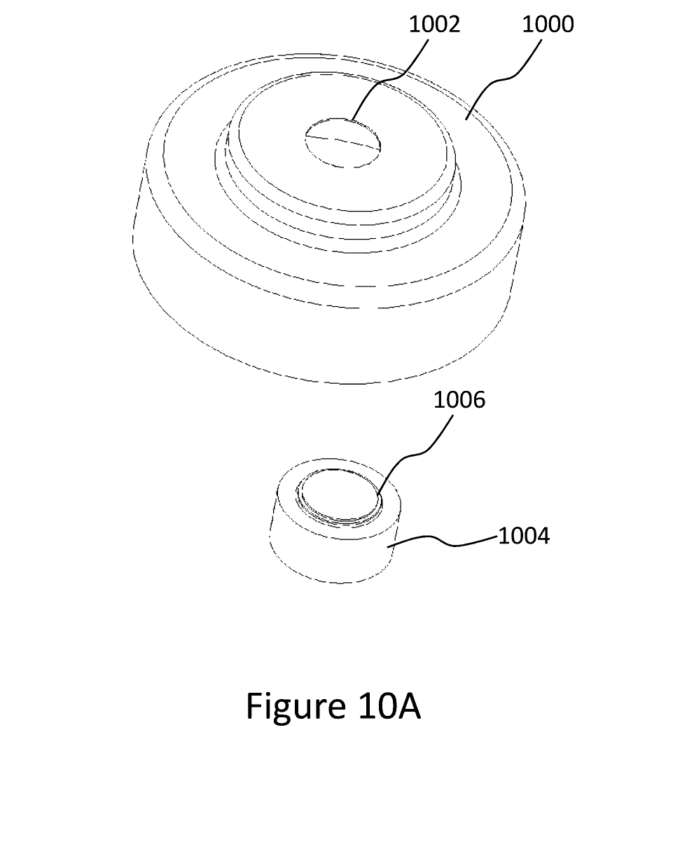

FIG. 7 is a simplified perspective view showing the use of separate laser optic assemblies 200a and 200b to effect removal of the pre-coat material and to perform laser welding in a single pass. In particular, a first laser optic assembly 200a receives laser light from a first continuous-wave laser source via a first fiber, referred to collectively as first laser source 204a, and launches a defocused laser beam 206 toward contiguous surface areas of the plates on either side of the interface 108. The defocused laser beam 206 melts material of the pre-coat layer 106 within the contiguous surface areas, but does not vaporize and expel the melted material. Rather, a conduit 202 is used to direct a stream of a gas at the melted material with sufficient force to blow the melted material out of the contiguous surface areas. The conduit 202 is in fluid communication with a source of high-pressure gas (not shown). A second laser optic assembly 200b, which trails behind the first laser optic assembly 200a in the scan direction, receives laser light from a second continuous-wave laser source via a second fiber, referred to collectively as second laser source 204b, and launches a focused laser beam 208 toward the interface 108 to form a laser-weld joint 400 between the plates. In particular, the focused laser beam is directed toward a region along the interface 108 from which the melted material has been blown out. Separate laser sources 204a and 204b are used to generate the defocused laser beam 206 and the focused laser beam 208, respectively.

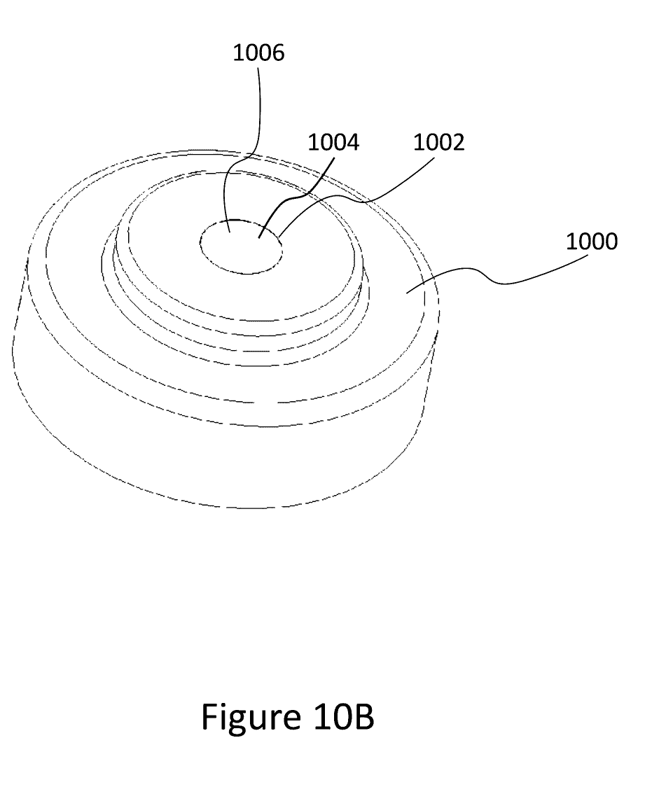

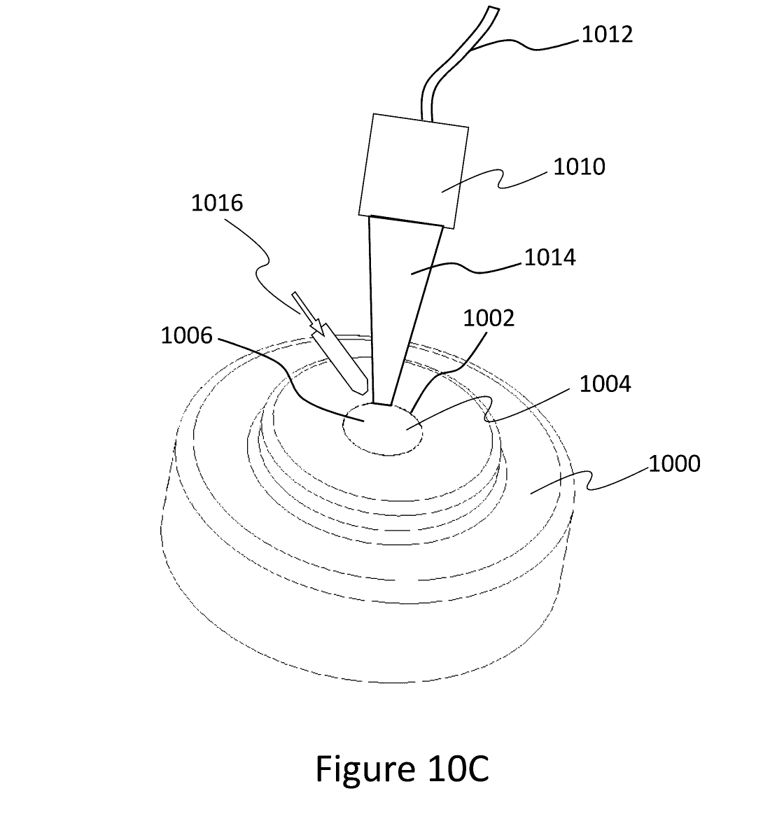

FIGS. 8 and 9 illustrate an optional embodiment, in which the laser beam is shaped using optics to achieve the removal of the pre-coat layer. In the specific and non-limiting example that is shown in FIGS. 8 and 9, a laser beam optic is used to produce a shaped dual-beam laser spot. FIG. 8 is a simplified top view showing a first pre-coated plate 800 and a second pre-coated plate 802 arranged side-by-side, defining an interface 804 therebetween. In the specific and non-limiting example that is shown in FIG. 8, a dual-beam optic is used to produce the shaped laser spot 806, which is scanned along the interface 804 between the plates 800 and 802, thereby removing pre-coat material within area 808. FIG. 9 is a simplified perspective view showing the first and second plates 800 and 802, and showing the dual-beam optic 900 forming the shaped laser beam 902 that produces the shaped laser spot 806. In the example that is shown in FIGS. 8 and 9, the steel substrates 904 and 906 of the plates 800 and 802, respectively, are of substantially they same thickness and the pre-coat layer 908 on each of each plates 800 and 802 is also of substantially the same thickness. This type of beam shaping is also beneficial when processing plates that have substrates of different thicknesses that are to be joined together by laser welding.

The processes that are described above with reference to FIGS. 2-9 are carried out in a single workstation. The workstation includes a support, such as for instance a fixture, for holding the assembly of plates during removal of the material of the pre-coat layer and during laser welding. Due to the single set-up, the laser beam paths for removing the pre-coat material and for laser-welding are very closely matched. It therefore becomes possible to set the effective width of the contiguous areas from which the material of the pre-coat layer is removed to a value that is optimum for welding. In this way, the full protective pre-coat layer remains intact adjacent to the laser weld joint 400, and at the same time the laser weld joint is not weakened by the formation of intermetallic areas. A not-illustrated roller assembly, which is arranged to roll along a free edge of one of the plates, may be used to ensure precise positioning of the heating spot of the defocused laser beam. The temperature at the heated spot can be monitored based on its infrared emission, and the obtained temperature data can be used to control the laser source power to melt only a desired portion of the pre-coat layer, while ensuring that the substrate material remains solid.

In the processes that are described above with reference to FIGS. 2-9, the entire pre-coat layer 106 is removed within the areas that are adjacent to the interface 108, along which the laser weld-joint 400 is formed. As such, the metal alloy layer and the intermetallic alloy layer are removed, and the underlying steel substrates 102 and 104 are exposed. Optionally, the intermetallic alloy layer is left undisturbed or is only partially removed and the metal alloy layer is completed removed within the areas adjacent to the interface 108. Further optionally, the metal alloy layer, the intermetallic alloy layer and additionally a relatively small amount of the steel substrate 102 and 104 are removed. Removal of a small amount of the steel substrate does not affect the weld if plates being joined have different thicknesses.

Of course, the process and system as described above are useful for laser welding pre-coated workpieces in other applications as well. For instance, an aluminum-silicon pre-coated steel sheet may be hot formed to produce a first workpiece having a desired shape, which is then joined by laser welding to a second workpiece such as a machined part, using the process and system substantially as described above. In this latter application, it is necessary to remove pre-coat material only from the first workpiece, since the second workpiece does not have a pre-coat layer. Alternatively, one edge of a sheet-formed workpiece is joined to another edge of the same sheet-formed workpiece, or to an edge of another sheet-formed workpiece, in which case it is necessary to remove pre-coat material from along both joined edges.

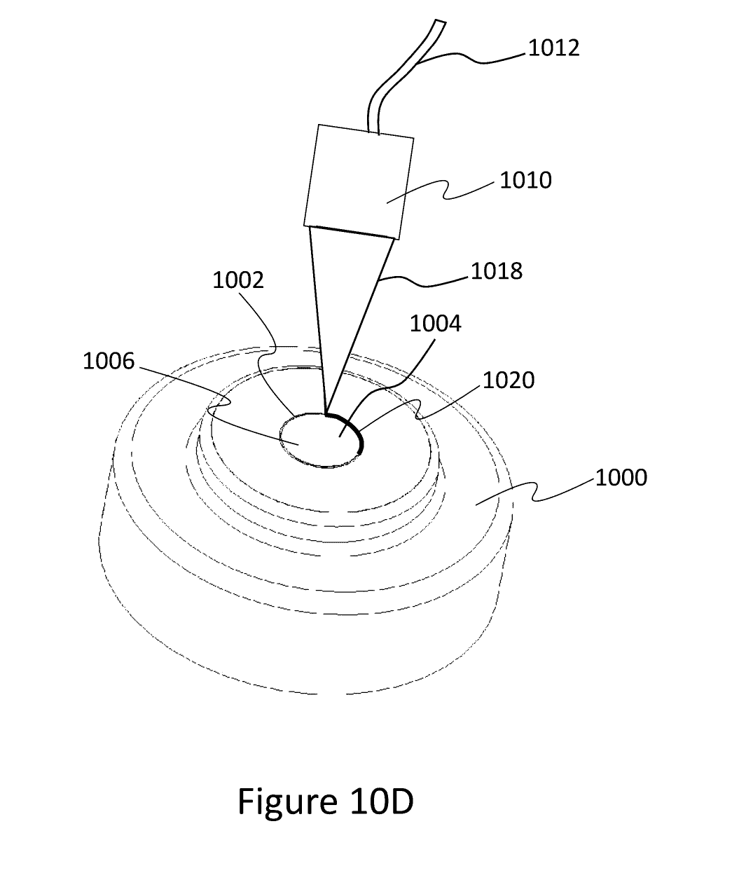

Referring now to FIGS. 10A-D, illustrated is a process for joining a formed component to a machined part, in accordance with an embodiment. FIG. 10A shows a formed part 1000 with a central opening 1002. By way of a specific and non-limiting example, the formed part 1000 is a hub in a gear component. For instance, the formed part 1000 is fabricated from an Al—Si pre-coated boron steel sheet blank, such as Usibor®. The blank is then heated to above its austenitization temperature and is formed into its final shape in a tool, followed by rapid quenching.

Also shown in FIG. 10A is a machined part 1004 with a central protrusion 1006 formed at one end thereof. As is shown in FIG. 10B, the protrusion 1006 is shaped and sized to be received within the central opening 1002 of the formed part 1000, after which the formed part 1000 and machined part 1004 are to be joined together by laser welding. Unfortunately, the Al—Si coating can cause severe cracking in the weld, as described previously.

Referring now to FIG. 10C, the formed component 1000 and the machined part 1004 are shown in an assembled condition, such that the protrusion 1006 is received within the central opening 1002. FIG. 10C illustrates a step of localized removal of the Al—Si coating from the surface of the formed component 1000, around the perimeter of the central opening 1002 therein. In particular, laser optic assembly 1010 receives laser light from a continuous-wave laser source via a fiber, referred to collectively as laser source 1012, and launches a defocused laser beam 1014 toward an area of the formed component 1000 that is immediately adjacent an interface between the formed component 1000 and the machined part 1004. Since the machined part does not have an Al—Si coating, the defocused laser beam may be directed only onto the formed part 1000. By way of an example, the laser optic assembly 1010 includes at least a lens, and the fiber of the laser source 1012 is either a single core fiber or a multiple core fiber bundle. The defocused laser beam 1014 melts material of the Al—Si coating adjacent to the interface, that is to say around perimeter of the central opening 1002, but does not vaporize and expel the melted material. Rather, a conduit 1016 is used to direct a stream of a gas toward the melted material and with sufficient force to blow the melted material off the underlying steel substrate of the formed part 1000, prior to the melted material re-solidifying. The conduit 1016 is in fluid communication with a source of high-pressure gas (not shown). It is to be understood that as depicted in FIG. 10C, the parts are not mechanically joined together but are merely arranged and held in a fixture or another suitable support. More particularly, each part is positioned and held firmly in place relative to the other during removal of the Al—Si coating and during subsequent laser welding. As shown in FIG. 10D, the same laser optic assembly 1010 and laser source 1012 that were used to remove the Al—Si coating material are also used to direct a focused laser beam 1018 along a weld line to form a laser-weld joint 1020 between the formed component 1000 and the machined part 1004. The conduit 1016 is not shown in FIG. 10D, for improved clarity.

The laser-weld joint 1020 is formed during a second pass after the material of the Al—Si coating has been removed during a first pass. The laser optic assembly 1010 may be scanned in the same direction during the second pass for forming the laser-weld joint 1020, and during the first pass for removing the material of the Al—Si coating. Optionally, the laser optic 1010 is scanned in opposite directions for forming the laser-weld joint 1020 and for removing the material Al—Si coating.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Numerical ranges include the end-point values that define the ranges. For instance, “between 1100° C. and 1200° C.” includes both 1100° C. and 1200° C., as well as all temperature values between 1100° C. and 1200° C.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

What is claimed is:

1. A process for laser-welding, comprising:
at a work station, arranging a first workpiece relative to a second workpiece such that the first and second workpieces abut one another along an interface, at least one of the first and second workpieces comprising a steel substrate and a pre-coat layer, the pre-coat layer comprising an intermetallic alloy layer that is in contact with the underlying steel substrate as well as a metallic alloy layer that is in contact with the intermetallic alloy layer;
scanning a defocused laser beam along the interface between the first and second workpieces, thereby melting the material of the pre-coat layer within an area that is immediately adjacent to the interface;
during scanning of the defocused laser beam and prior to the melted material re-solidifying, directing a stream of a gas toward the melted material, the stream of gas providing sufficient force to blow the melted material off the underlying steel substrate of the at least one of the first and second workpieces; and
absent transferring the first and second workpieces from the work station to another work station, scanning a focused laser beam along the interface to form a laser weld joint.

2. The process according to claim 1, comprising using only one laser source for melting the material of the pre-coat layer and for forming the laser weld joint.

3. The process according to claim 1, wherein melting the material of the pre-coat layer and forming the laser weld are performed in a single pass.

4. The process according to claim 3, comprising splitting a source laser beam using a beam splitter to form the defocussed laser beam and the focused laser beam.

5. The process according to claim 3, comprising using a first laser source to form the defocused laser beam and using a second laser source to form the focused laser beam.

6. The process according to claim 1, wherein melting the material of the pre-coat layer is performed in a first pass and forming the laser weld is performed in a second pass.

7. The process according to claim 6, comprising using only one laser source for melting the material of the pre-coat layer and for forming the laser weld joint.

8. The process according to claim 6, comprising using a first laser source to form the defocused laser beam and using a second laser source to form the focused laser beam.

9. The process according to claim 1, wherein the melted material consists of melted metal alloy material.

10. The process according to claim 1, wherein the melted material consists of melted metal alloy material and melted intermetallic alloy layer material.

11. The process according to claim 1, wherein the melted material consists of melted metal alloy material, melted intermetallic alloy layer material and melted material from the steel substrate.

12. The process according to claim 1, wherein scanning the defocused laser beam comprises using beam shaping optics to shape the defocused laser beam.

13. The process according to claim 12, wherein the beam shaping optics is a dual-beam optic.

14. The process according to claim 1, wherein only one of the first and second workpieces comprises the pre-coat material.

15. The process according to claim 14, wherein the one of the first and second workpieces is a sheet formed part.

16. The process according to claim 1, wherein both the first and second workpieces comprise the pre-coat material.

17. The process according to claim 16, wherein the first and second workpieces are pre-coated sheet metal plates, which are for being welded together to form a butt-welded blank.

18. The process according to claim 1, wherein the area within which the material of the pre-coat layer is melted is substantially the same size as the laser weld joint.

19. A system for laser-welding, comprising:
a support for holding a first workpiece in a predetermined orientation relative to a second workpiece, such that the first workpiece abuts the second workpiece along an interface, at least one of the first and second workpieces comprising a steel substrate having a pre-coat layer formed thereon;
at least one laser optic assembly in optical communication with a laser source,
at least one actuator for relatively moving the at least one laser optic assembly relative to the support; and
a conduit in communication with a source of a gas for directing a stream of the gas toward a predetermined point along the interface between the first workpiece and the second workpiece,
wherein during use the at least one actuator moves the at least one laser optic assembly relative to the support such that the at least one laser optic assembly scans a defocused laser beam along the interface to melt the material of the pre-coat layer within an area that is immediately adjacent to the interface, and such that the at least one laser optic assembly subsequently scans a focused laser beam along the interface to form a laser weld joint, and
wherein the predetermined point along the interface is a point that is behind the defocused laser beam in the scan direction, and the stream of the gas provides sufficient force to blow the melted material of the pre-coat off the underlying steel substrate of the at least one of the first and second workpieces, prior to scanning the focused laser beam to form the laser weld joint.

20. The system according to claim 19, wherein the at least one laser optic assembly consists of one laser optic assembly.

21. The system according to claim 20, wherein the one laser optic assembly comprises a beam splitter for forming the defocussed laser beam and the focused laser beam.

22. The system according to claim 19, wherein the at least one laser optic assembly consists of a first laser optic assembly to form the defocused laser beam and a second laser optic assembly to form the focused laser beam.

23. The system according to claim 19, wherein the at least one laser optic assembly comprises a beam shaping optic.

24. The system according to claim 23, wherein the beam shaping optic is a dual-beam optic.

25. The system according to claim 19, wherein only one of the first and second workpieces comprises the pre-coat material.

26. The system according to claim 25, wherein the one of the first and second workpieces is a sheet formed part.

27. The system according to claim 19, wherein both the first and second workpieces comprise the pre-coat material.

28. The system according to claim 27, wherein the first and second workpieces are pre-coated sheet metal plates, which are for being welded together to form a butt-welded blank.

29. The system according to claim 19, wherein the area within which the material of the pre-coat layer is melted is substantially the same size as the laser weld joint.
